(19) United States
(12) Patent Application Publication
(10) Pub. No.: US 2006/0085442 A1
(43) Pub. Date: Apr. 20, 2006

(54) Document image information management apparatus and document image information management program

(75) Inventor: Akihiko Fujiwara, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/968,270

(22) Filed: Oct. 20, 2004

(51) Int. Cl. G06F 17/30

(52) U.S. Cl. 707/100

(57) ABSTRACT

Metadata of document images can be universally handled by dealing with the document images in units of individual regions according to their contents, thereby making it possible to improve convenience for management, search, operation thereof and so on. In order to mange metadata of contents and contexts related to the document images, prescribed image regions are analyzed as image objects based on image contents of the document images, and attribute information is extracted based on contents of the image objects thus analyzed, so that the metadata of the contents thus extracted is managed in association with the document images and the image objects. Also, attribute information is extracted based on a situation of the documents of the document images, so that the metadata of the contexts extracted is managed in association with the document images and the image objects.

### BACKGROUND OF THE INVENTION

1. Field of the Invention

The present invention relates to a document image information management apparatus and a document image information management program for managing metadata of contents and contexts related to document images.

2. Description of the Related Art

In the management of document image information in conventional document image information management apparatuses, entities such as files constructed according to specific formats are managed as a whole or in units of individual pages contained therein, and pieces of metadata for contents, contexts, instances thereof in those units are collected and registered so that the respective pieces of metadata thus collected are associated with corresponding document images so as to be utilized for the management, operation and search of the document images.

Here, note that Japanese patent application laid-open No. 2002-116946, for example, is known as a patent document relevant to such a prior art.

In the conventional document image information management apparatus, however, there arises the following problem. That is, only the metadata that depends on the units set in the apparatus can be handled, so for example, in case where a specific region in a certain image is copied or pasted to another document as an image, the metadata held by an original document cannot be succeeded.

This is similar in the case of specific metadata that depends on a document input-output system such as an image reading device, an image forming device, etc. That is, there was a problem in that for example, in cases where the metadata of contents obtained by analyzing a document image scanned, the metadata of contexts such as the person and the date and time of scanning, and the metadata of instances such as the location of storage, the size of the document image are handled in an integrated manner, even if a specific region of the scanned document image (e.g., a region taken as a title) were extracted as an image, there would be lost information such as by whom and when the image in that region was originally obtained through scanning or the like.

### SUMMARY OF THE INVENTION

The present invention is intended to obviate the problems as referred to above, and has for its object to provide a document image information management apparatus and a document image information management program which are capable of universally handling the metadata of document images by dealing with them in units of individual regions according to their contents, thereby making it possible to improve convenience for management, search, operation thereof and so on.

In order to solve the above-mentioned problems, the present invention resides in a document image information management apparatus for managing metadata of contents and contexts related to document images, the apparatus comprising: an image analyzing section that analyzes prescribed image regions as image objects based on image contents of the document images; a content metadata extraction section that extracts attribute information based on contents of the image objects analyzed by the image analyzing section; a content metadata management section that manages metadata of the contents extracted by the content metadata extraction section in association with the document images and the image objects; a context metadata extraction section that extracts attribute information based on a situation of documents of the document images; and a context metadata management section that manages the metadata of the contexts extracted by the context metadata extraction section in association with the document images and the image objects.

Moreover, the present invention resides in a document image information management program for making a computer perform management of metadata of contents and contexts related to document images, the program adapted to make the computer execute: an image analyzing step of analyzing prescribed image regions as image objects based on image contents of the document images; a content metadata extraction step of extracting attribute information based on contents of the image objects analyzed in the image analyzing step; a content metadata management step of managing metadata of the contents extracted in the content metadata extraction step in association with the document images and the image objects; a context metadata extraction step of extracting attribute information based on a situation of documents of the document images; and a context metadata management step of managing the metadata of the contexts extracted in the context metadata extraction step in association with the document images and the image objects.

### BRIEF DESCRIPTION OF THE DRAWINGS

FIG. 1 is an overall block diagram showing a document image information management system in an embodiment of the present invention.

FIG. 2 is a network block diagram of this system.

FIG. 3 is a view explaining the concept of a document in the embodiment of the present invention.

FIG. 4 is a flow chart illustrating the operation of a first embodiment of the present invention.

FIG. 5 is a view showing one example of a management table for a document image in a document image management section.

FIG. 6 is a view showing one example of a management table for an image object in the document image management section.

FIG. 7 is a view showing one example of a management table for content metadata in a content metadata management section.

FIG. 8 is a view showing one example of a management table for context metadata in a context metadata management section.

FIG. 9 is a flow chart illustrating the operation of a second embodiment of the present invention.

FIG. 10 is a view showing a screen that is formed by a search result screen forming section.

FIG. 11 is a flow chart illustrating the operation of a third embodiment of the present invention.

FIG. 12 is a view showing one example of a management table for context metadata in the third embodiment.

### DESCRIPTION OF THE EMBODIMENTS

Hereinafter, preferred embodiments of the present invention will be described in detail while referring to the accompanying drawings.

Here, in the following description, it is assumed that XX in [XX] represents the name of metadata, and XX in “XX” represents the value or content of the metadata. In addition, respective parts or sections (e.g., an image analyzing section) indicated by respective blocks in some figures can be constituted, as required, by hardware or software (modules) or a combination thereof.

Further, note that a document means a document file of an application or a data file with a format such as an graphics format, an audio format or the like. In addition, the entity of a document means an actual substance that depend on the style or format by which the document is described, and for example, in a Windows (registered trademark) file system, it means a file that is managed thereon, and in a document management system, it means a data record or the like stored in a database that manages images thereon. As styles or formats, there are TIFF, PDF (registered trademarks), storage forms specific to document management systems, and so on.

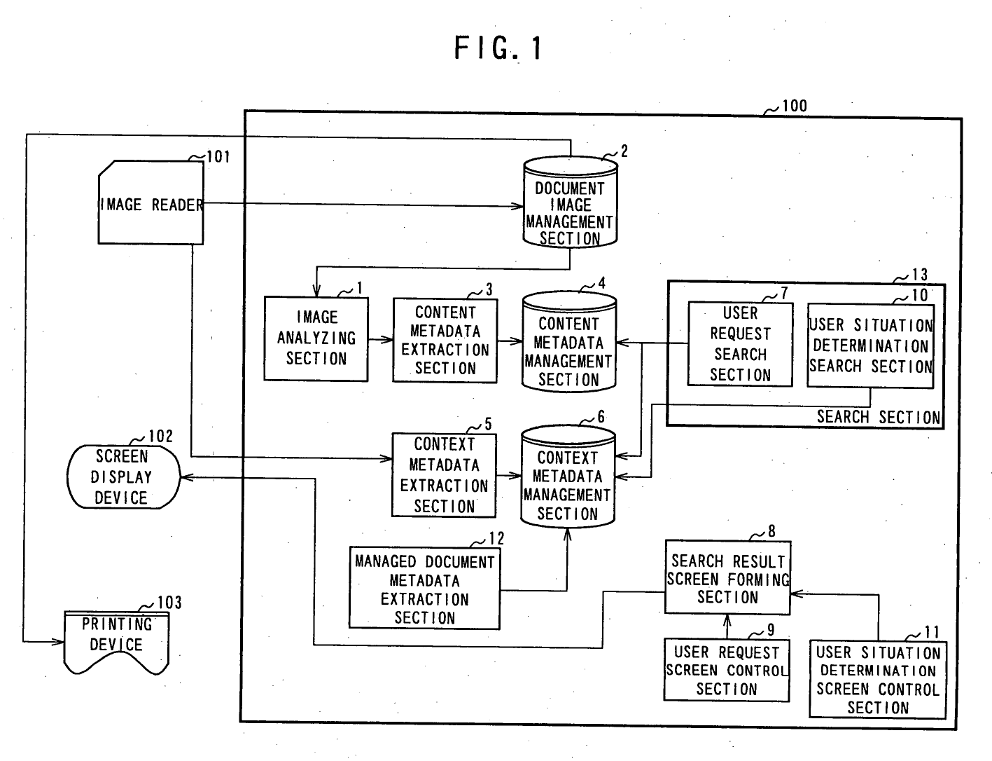

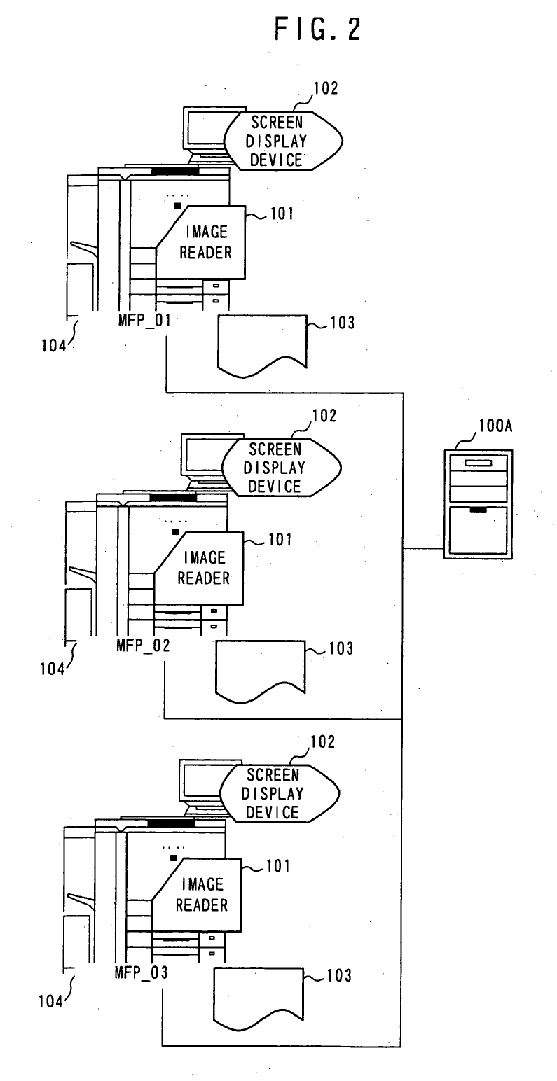

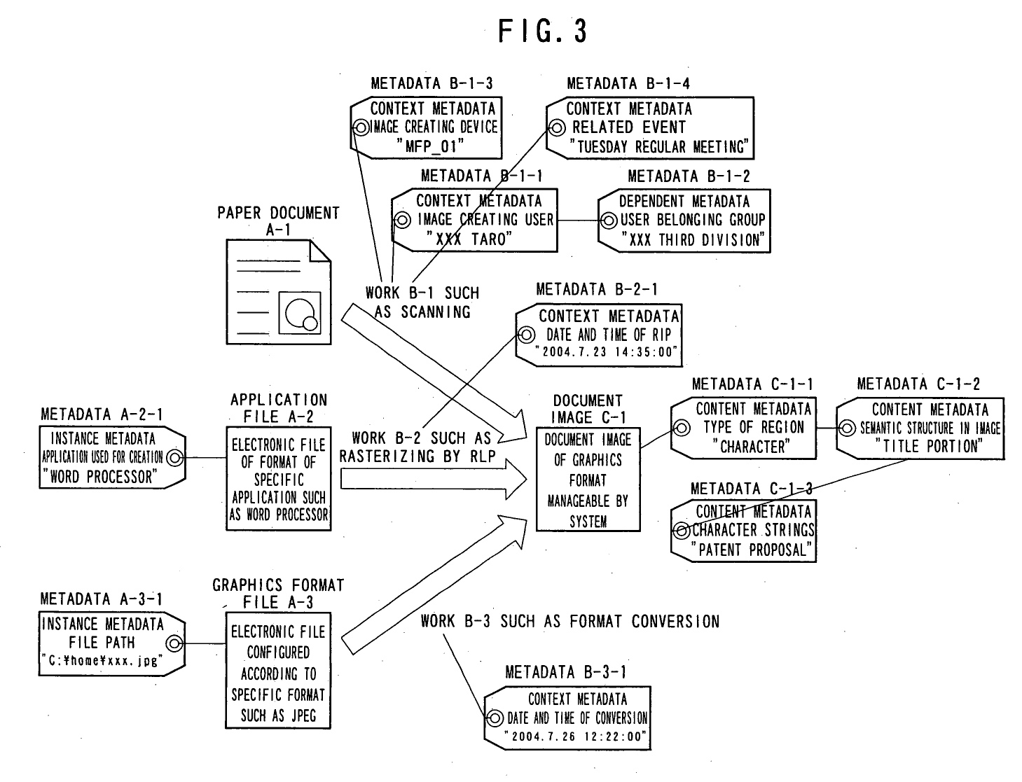

FIG. 1 is an overall block diagram that illustrates a document image information management system in an embodiment of the present invention. FIG. 2 is a network block diagram of this system. FIG. 3 is a view that describes the concept of a document in this embodiment.

A document image management section 2 is a part that serves to manage document images and image objects, and for example, it manages, as records in a table in a relational database system, identifiers that are capable of uniquely recognizing the document images and the image objects in the interior of the table.

A content metadata extraction section 3 is a part that serves to extract metadata related to the contents of documents, and it extracts, from image regions extracted by the image analyzing section 1, pieces of semantic attribute information that are possessed by the image regions. For example, with respect to a region recognized as a character region, it extracts, as metadata, identification information on the type of the region (type=character, etc.), its coordinate information, text information obtained as a result of the optical character recognition (OCR of the character region, and so on.

In case where a document exists as image information, the content metadata thereof includes a distinction between a character region, an image region and a diagram region, region coordinates and region areas thereof, individual occupation ratios thereof in the entire image, character color, fonts, character size, character type information, configuration information that is obtained as a result of a layout analysis (region coordinates, region areas and occupation ratios in the entire image, of a region that appears to be a title, a region that appears to be a date, etc.) and so on.

In case where a document exists in a form or style having document configuration information (e.g., a form having, as data, font information, column information, etc., together with text information of a document maim body such as a file format of a word processor application, XML, etc.), the content metadata includes corresponding regions, their data and semantic attribute titles, names of creators, etc.).

A content metadata management section 4 is apart that serves to manage an original document image, its image object and content metadata extracted therefrom by associating them with one another. For example, in a table of a relational database system, it manages content metadata corresponding to the identifiers of document images and image objects that are managed by the document image management section 2, as records associated with the content metadata in the interior of the table.

A context metadata extraction section 5 is a part that serves to extract operations and works to documents as well as semantic attribute information possessed by a situation such as a peripheral environment under which the documents are placed. For example, if a document image is an image obtained by scanning a paper document by means of a document input device, information such as who the user having scanned the document is, what the group to which the user belongs is, as information dependent on it, is extracted as metadata. As such an image input device, there are enumerated an image reader (scanner), a communication device (FAX), and so on.

Here, note that the context metadata of a document includes attribute and/or property information such as the creator of the document, the group to which the creator belongs, the place in which the creator is mainly resident, users of the document, the group or groups to which the users belong, the place or places in which the users are mainly resident, the date and time of creation, the weather at the time of creation, the environment around the creator at the time of creation, the dates and times of use, the weathers at the times of use, the environments around the users, etc.

A context metadata management section 6 is a part that serves to manage the document image and the image object of a target document as well as the context metadata extracted therefrom by associating them with one another, and for example, in a table in a relational database system, it manages context metadata corresponding to the identifiers of the document image and the image object managed by the document image management section 2 as records associated with the identifiers.

A user request search section 7 is a part that serves to perform a search upon receipt of an image search request from a user, and for example, it creates (issues) a search key in accordance with a request from the user for searching for images matching the values of specific metadata, receives the identifiers of document images and image objects matching the search key from the content metadata management section 4 and the context metadata management section 6 as a result of the search, and acquires images matching the identifiers from the document image management section 2.

A search result screen forming section 8 is a part that serves to form a screen on which the document images and the image objects obtained as the search result in the user request search section 7 are presented to the user. For example, when a plurality of images matching the search key are acquired from the document image management section 2, it forms a screen to present the image objects to the user in a list by sorting them by the values of another metadata.

A user request screen control section 9 is a part that serves to control the display of the screen formed by the search result screen forming section 8 in accordance with a user request, and for example it displays a list screen (i.e., changes the display or indication) by filtering or resorting the screen, which lists the image objects once sorted by the values of certain metadata, by the values of another metadata.

A user situation determination search section 10 is a part that serves to perform a search upon receipt of an image search request according to the situation under which the user is placed. For example, in case where a plurality of image readers 101 for registering a plurality of images are connected to a document image information management apparatus 100 with screen display devices 102 being connected to the printing devices 103, respectively, as shown in FIG. 2, when the user controls a certain screen display device 102 in a search of documents, this user situation determination search section 10 can recognize that the user controls that screen display device 102. As a result, it is determined, as the situation under which the user is placed, that the user lies beside a printing device 103 which is connected to the particular screen display device 102, whereby it is possible to automatically perform a search through the already registered document images which have been scanned by this specified printing device 103.

The user situation determination screen control section 11 is a part that serves to control only with the user's situation with respect to the screen formed by the search result screen forming section 8. For example, it is able to recognize the date and time at which the screen formed by the search result screen forming section 8 is displayed on the screen display device 102, so that a regular event can be specified therefrom as being associated with a current operation. Then, a list screen is displayed by automatically filtering the screen listing the document images by a filter of the documents scanned at timing for the event thus specified.

A managed document metadata extraction section 12 is a part that serves to extract semantic attribute information which is possessed by the processing performed on the already registered document images.

The printing device 103 prints on paper the contents of an image file of an electronic format (PDF, TIFF, etc.), a document created by an application (document file or the like created by a word processor application, etc.) which have been converted into an appropriate format such as a bitmap.

As shown in FIG. 3, the documents handled by the present invention are classified, according to the conditions of media, into paper documents A-1 drawn or printed on paper, application files A-2 in the form of electronic files of specific application formats for word processors or the like, graphics format files A-3 such as electronic files formed in accordance with specific formats such as JPEG, and so on.

With respect to electronically existing documents, there exist metadata for instances such as [applications used for creation], [file paths], etc.

In addition, in order to provide document images of graphics formats that can be managed by the system, it is necessary to do, as a work B-1 such as scanning, an image pickup operation by the use of the image reader 101 of a document input device, a digital camera or the like. Moreover, it is also necessary to do, as another work B-2 such as rasterizing by a RIP, a conversion operation for converting various formats, for example, into a bitmapped format by means of a driver compatible with the printing device 103 of a document output device in accordance with a print request from an application. Further, it is also necessary to do, as a further work B-3 such as format conversion, another conversion operation for converting existing files of graphics formats into a specific format so as to register them into the system.

When the document images are registered into the system, there exist metadata for contexts such as [image creating users], [dates and times of conversion], etc., for these works. In addition, with respect to the [image creating users], there also exist dependent metadata such as [user belonging groups] to which the users belong. Thus, in order to acquire such dependent metadata, it is necessary to provide user management data inside or outside the system so that inquiries can be made as required.

### Embodiment 1

Now, a first embodiment of the present invention will be described below in detail. In the construction of FIG. 1 as stated above, the first embodiment can be constructed to include the image analyzing section 1, the document image management section 2, the content metadata extraction section 3, the content metadata management section 4, the context metadata extraction section 5, the context metadata management section 6, the user request search section 7, the search result screen forming section 8, and the user request screen control section 9. As an example of processing performed in the first embodiment, reference will be made to the case where after an image analysis is performed with respect to a document image obtained by reading a paper document by means of the image reader 101 such as a scanner, content metadata is extracted therefrom, and context metadata upon scanning is extracted, so that these pieces of metadata are managed together with the document image and image objects.

Here, the paper document is scanned by the image reader 101, and the content of an image is analyzed with respect to a document image thus acquired, so that the content metadata of a [title] is extracted. In addition, upon scanning, the user who performed the scanning by means of the image reader 101 is also extracted, and these pieces of metadata are managed together with the document image and the image object corresponding to the title.

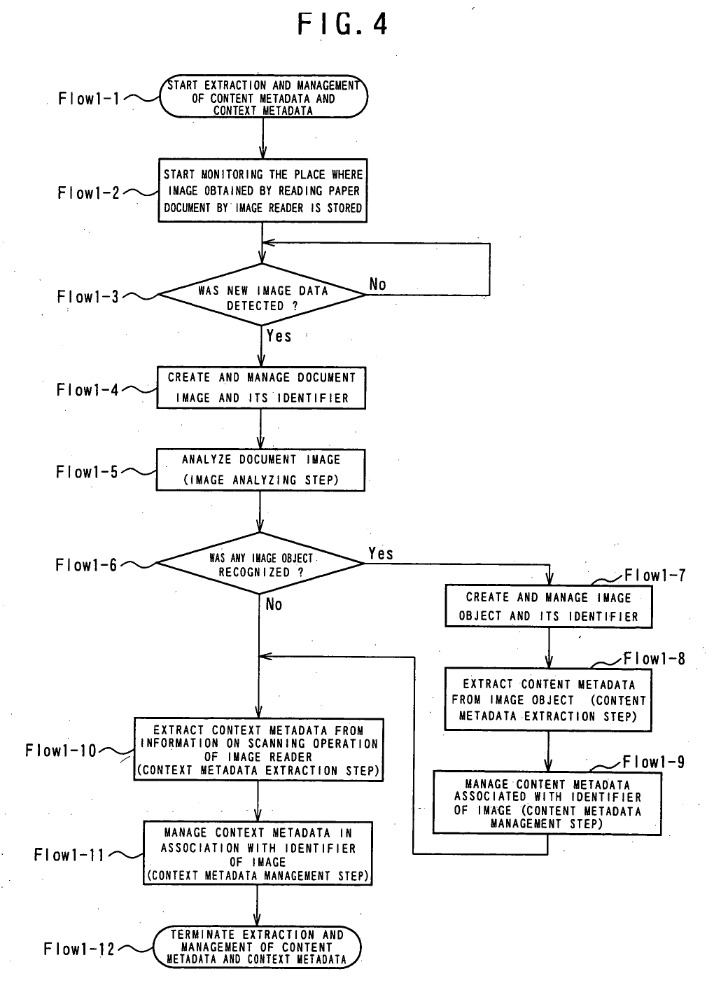

In the following, reference will be made to the operation of the first embodiment of the present invention while using a flow chart illustrated in FIG. 4.

First of all, the image analyzing section 1 starts monitoring the place where the document image obtained by scanning paper documents by means of the image reader 101 is kept or stored (Flow 1-2). The document image obtained herein has a format depending upon the image reader 101, and is converted as required into another format which can be analyzed by the image analyzing section 1.

Although in this example, the document image kept in this storage location is the document image scanned by the image reader 101, this invention includes not only the case where the image reader 101 is included in this system, but also the case where scanned document images are sent as data to storage locations of the system through the connection function of a network. Other than these, images can be received through fax transmissions and stored as image data, or files attached to electronic mails can be automatically converted into image data and stored as such, or images copied by a copier can be printed on paper and at the same time stored in electronic form. In addition, images ca be stored by the works B-2 and B-3 in FIG. 3.

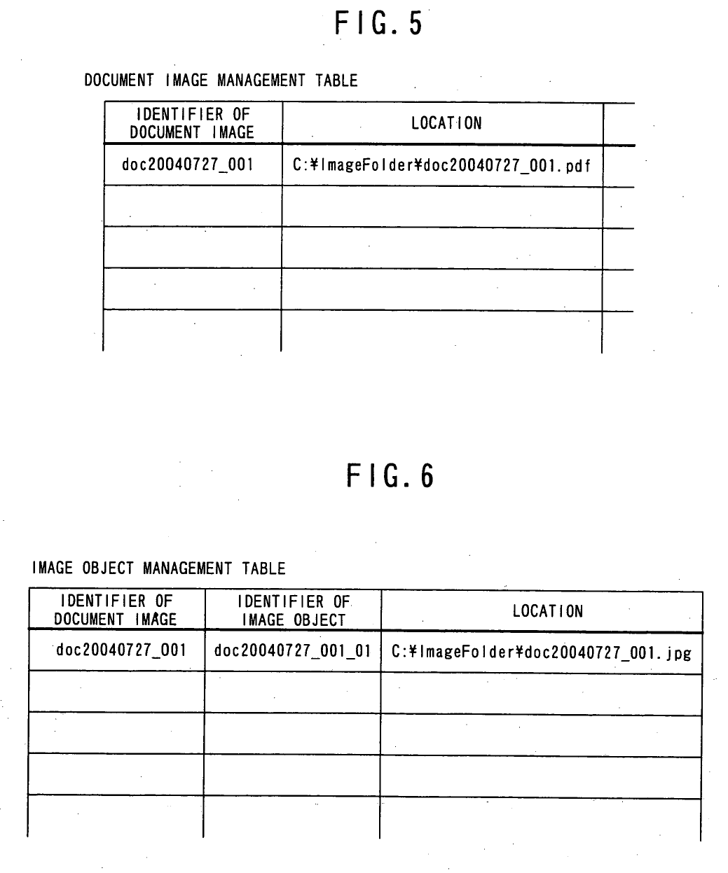

When new image data is detected in a storage location as a result of these (Flow 1-3), a corresponding document image is managed by the document image management section 2 while being assigned with an identifier that can be uniquely identified (Flow 1-4). In the document image management section 2, the identifier (doc20040727_{—}001) of the document image and the location (C:¥ImageFolder¥doc20040727_{—}001.pdf) of the document image are described and managed in a table (management table for document images) of a relational database system by a file path of a file system, as shown in FIG. 5. Other than this, it can be considered that the document image is directly stored in the table as a binary record. In this example, the document image is managed in a PDF format, and a plurality of pages thereof having been scanned are collectively organized into a single file (doc20040727_{—}001.pdf).

Subsequently, the image analyzing section 1 analyzes the document image (an image analyzing step) (Flow 1-5). In this analysis, the image is analyzed according to a conventionally known technique, i.e., the image is converted for example into binary pixels, so that regions in which the pixels exist are blocked so as to analyze the image through their tendency. According to this analysis, it is recognized whether the document image contains an image object having a prescribed collection (Flow 1-6).

If an image object is recognized in the document image, its region is divided into individual images. The thus divided individual image objects can be handled as separate images, and managed by the document image management section 2 while being assigned with identifiers that can be uniquely identified by the document image management section 2 (Flow 1-7). In the document image management section 2, the identifier (doc20040727_{—}001) of the original document image, the identifier (doc20040727_{—}001_{—}01) of its image object and the location (C:¥ImageFolder¥doc20040727_{—}001_{—}01.jpg) of the image object are described and managed in a table of the relational database system by a file path of the file system, as shown in FIG. 6. Other than this, it can be considered that the image object is directly stored in the table as a binary record.

In this example, image objects are managed in a JPEG format, and the individual image objects are managed as a single file doc20040727_{—}001_{—}01.jpg). Further, the content metadata extraction section 3 recognizes whether each image object is a certain semantic collection, and extracts therefrom metadata of contents in the image object (a content metadata extraction step: Flow 1-8). For example, when it is recognized from the tendency of the region blocked by the image analyzing section 1 that characters are described over a certain plurality of lines, the content metadata extraction section 3 extracts metadata indicating that the [type of the region] of the image object is a “character” (FIG. 3, metadata C-1-1). Also, it is recognized from the position and occupation ratio of the region in the image that the region is a part corresponding to a title in the document image, and metadata indicating that the [semantic structure of the image] is a “title portion” is extracted (FIG. 3, metadata C-1-2).

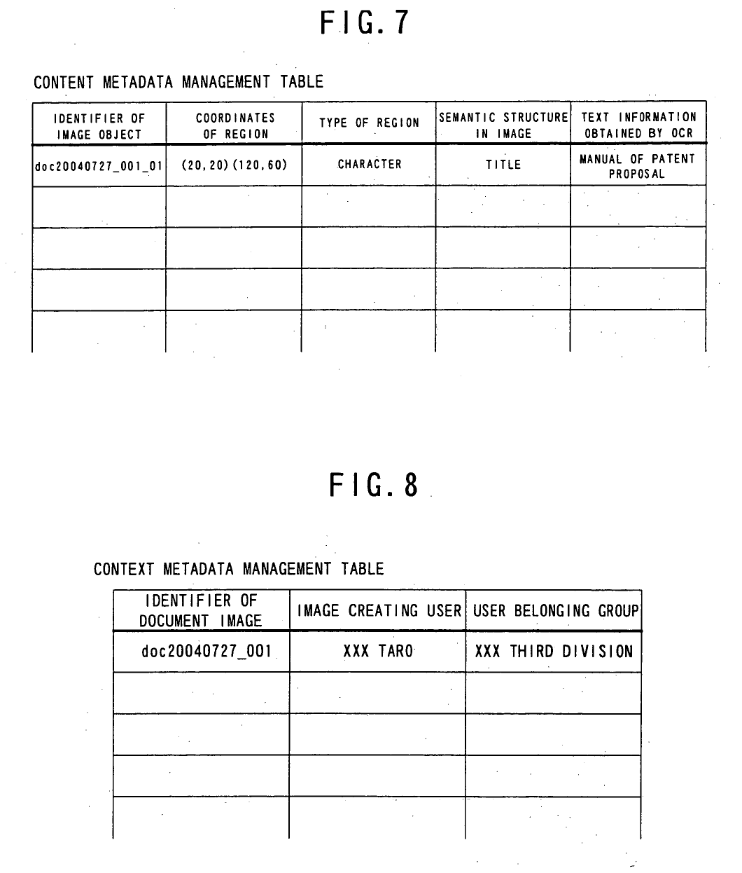

Moreover, character strings or sequences written in the image object can be extracted by a conventionally known OCR technology, so metadata is extracted which indicates that the character strings written in the title portion are “Patent Proposal” (FIG. 3, metadata C-1-3). The metadata of the content thus obtained is managed by the content metadata management section 4. Here, the metadata is managed by being associated with a uniquely identifiable identifier which is assigned to the image object by the document image management section 2 (a content metadata management step: Flow 1-9). In the content metadata management section 4, the identifier (doc2040727_{—}001_{—}01) of the target image object and the metadata of the content for the image object are managed in a table of the relational database system, as shown in FIG. 7.

The context metadata extraction section 5 acquires information on scanning operations in the image reader 101 and extracts metadata therefrom regardless of whether the image object was recognized in Flow of 1-6 (a context metadata extraction step: Flow 1-10). In this example, when a scanning operation is performed by the image reader 101, a user is requested to do a login operation with respect to the image reader 101. In the case of metadata “XXX Taro” being the name of the user who performed the login operation, assuming that the image reader 101 concurrently puts a file describing the user name into the storage location of the image,

the context metadata extraction section 5 can recognize the name of the user who performed scanning after the user's login by reading in the file, and extract the metadata of a context indicating that the [image creating user] is “XXX Taro” (FIG. 3, metadata B-1-1).

In addition, in case where groups to which users belong are separately managed, for example, where an integrated address book in an organization, an LDAP server or the like is operated, the group to which the user of concern belongs can be acquired from the integrated address book or the LDAP server, so that metadata of a context indicating that the user belonging group is “XXX third division” can be extracted (FIG. 3, metadata B-1-2).

Moreover, in case where the plurality of image readers 101 are connected to a server through a network, as shown in FIG. 2, this document image information management apparatus operates on the server of the network, each image reader 101 can be a device that provides a scanning function in a compound machine having a network communications function which can be arranged in plurality on the network.

In this case, an image reader 101 that performed a scanning operation can know the name of the device (MFP_{—}01) set by itself, whereby metadata of a context indicating that the [image creating device] is “MFP_{—}01” can be extracted (FIG. 3, metadata B-1-3).

Furthermore, an event related to the scanning operation can be estimated from the date and time at which this scanning was performed. For example, in case where event information such as meeting calling information, etc., is managed by a mailer or a schedule management system, when scanning was carried out by a certain device (MFP_{—}01) at a certain date and time, it can be estimated by making reference to the date and time and the place of holding of the event that the scanning was done in relation to what event.

Here, let us consider the case where a meeting called a “Tuesday regular meeting”, being held on every Tuesday, is registered in a schedule book, and the place of holding of the meeting is located near the installation site of “MFP_{—}01”.

When a certain scanning operation occurred, the context metadata extraction section 5 can estimate from registered event information and scanning operation information that this scanning operation was to scan meeting materials used by the “Tuesday regular meeting”, and extract metadata of a context indicating that the content of a [related event], being the name of the metadata, is “Tuesday regular meeting” (FIG. 3, metadata B-1-4). The extracted pieces of metadata of these contexts are managed by the context metadata management section 6 (a context metadata extraction step: Flow 1-11). Here, they are managed by being associated with identifiers which can be uniquely identified and which are assigned to the image objects by the document image management section 2. In the context metadata management section 6, the identifier (doc20040727_{—}001) of the target document image and the metadata of a context of the document image are managed in a table of the relational database system, as shown in FIG. 8. Secondary metadata such as a [user belonging group] obtained from data that is separately managed outside the system need not necessarily be managed by the context metadata management section 6, as shown in FIG. 8, but may be referred to the externally managed data at any time when a later mentioned inquiry is generated.

### Embodiment 2

In a second embodiment of the present invention, provision is further made for a user request search section 7, a search result screen forming section 8, and a user request screen control section 9 in addition to the configuration of the first embodiment.

Reference will be made, as an example of processing performed by these sections, to the case that achieves such a function as to facilitate a user in finding a document for a document image, which was registered by scanning, by browsing a list for its title regions, or to make it easier to find such a document by further designating a sorting of the list.

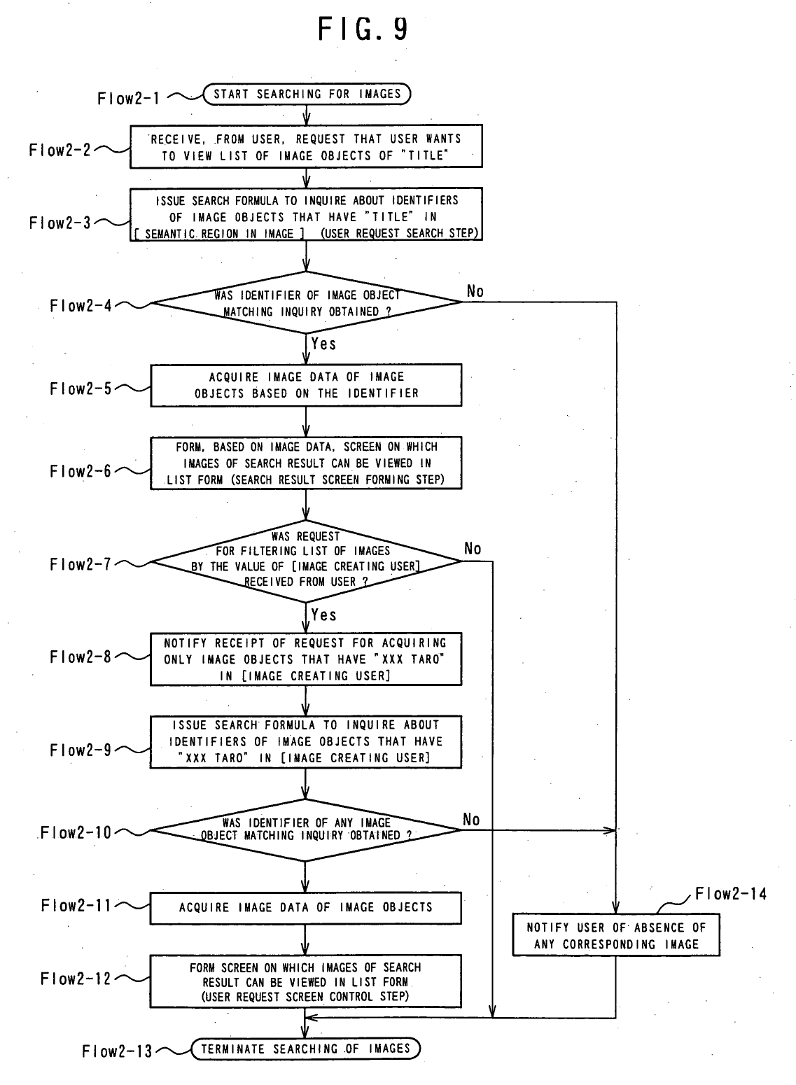

Here, the user searches for a document image already scanned by viewing or browsing a list of image objects which were analyzed from the scanned document image and displayed on the screen display device 102, and of which the [semantic structure in each image] was recognized as a “title”, and the user can make such a search with improved browserability or viewability of the list by further filtering the list by the value (the name herein) of the [image creating user]. Hereinbelow, reference will be made to the operation of the second embodiment of the present invention while using a flow chart shown in FIG. 9.

First of all, the user request search section 7 receives from a user a request that the user wants to view or browse already registered document images in a list of image objects recognized as their titles (Flow 2-2). This can be a case where this apparatus provides a screen on which such a user request is accepted, or another case where the later mentioned search result screen forming section 8 has a screen for displaying thereon a list of target images, so that the latest registered document image and image objects are displayed thereon each time they are registered, while automatically sending a user request to the user request search section 7.

The user request search section 7 issues to the content metadata management section 4 a search formula to inquire about the identifier(s) (one or more) of an image object which has a “title” in the value of the [semantic area of each image] a user request search step (a search step): Flow 2-3). If there exists an image object inquired about as a result of an assessment of this search formula with respect to the table of FIG. 7 (Flow 2-4), the user request search section 7 acquires image data of target image objects from the document image management section 2 by making inquiries to the table of FIG. 6 based on the identifier of the image object (Flow 2-5).

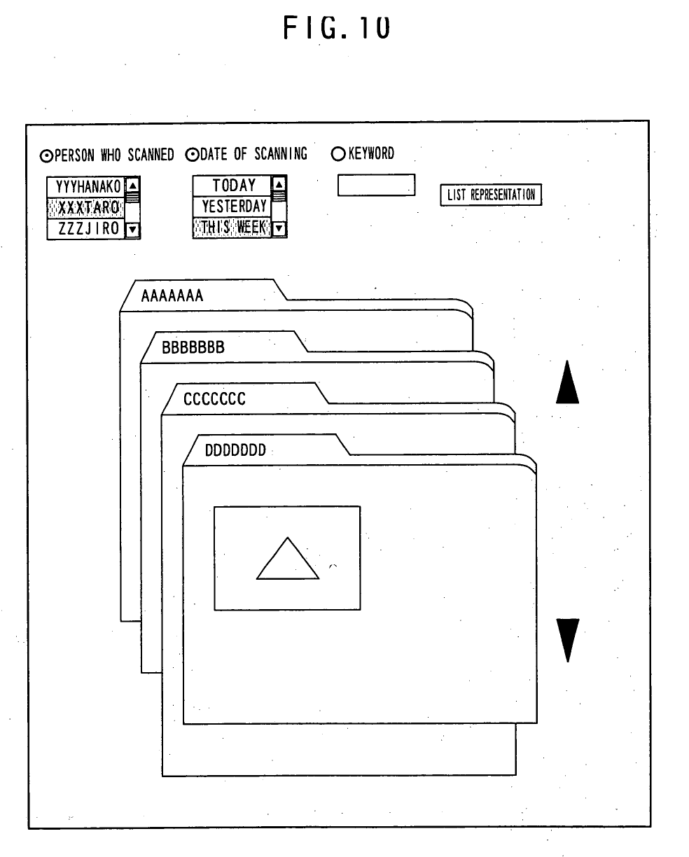

Next, the search result screen forming section 8 forms a screen to present a list of the image objects based on the image data thus acquired (a search result screen forming step: Flow 2-6). As shown in FIG. 10, this screen is such that only image objects with their “title” portions such as “AAAAAA” being in the form of extracted images themselves are arranged so as to be easily identified. The screen thus formed is presented to the user by being displayed on the screen display device 102. The user can easily find out a desired image by freely scrolling the screen arranged in this manner. In addition, when a desired document can be found based on the image object of its “title”, by forming, through designation of the image of the document by clicking for example, such a screen as to display an entire original document image or all the pages thereof if a plurality of pages exist, it is possible to ascertain the content thereof.

If there exists no corresponding image object in Flow 2-4 the search result screen forming section 8 notifies the user of the absence of any corresponding image (Flow 2-14). This can be notified to the user by a screen describing to that effect being formed by the search result screen forming section 8 and being displayed on the screen display device 102.

Although the user tries to search for a desired document from the list of image objects of the “title”, it is difficult for the user to find the desired document from there if there are a lot of image objects in this list. In such a case, the user can provide a filter condition so that only those which are in much with the condition can be listed, thereby making it easy to find the document.

Now, reference will be made, as such an example, to the case where the user sets, as a filter condition, only those images which were scanned by himself (XXX Taro) in the past. The user request screen control section 9 can receive from the user a request that the user wants to view a list of images by limiting those who scanned the images to a specific person (Flow 2-7). An instruction for such a request can be made by selecting, on a screen formed as shown in FIG. 10, a value for a filter condition expressed by such words as “person who scanned”. The values selectable here can be collected by registering them beforehand, acquiring a list of the values for the image creating users of documents registered in the past, etc.

In accordance with this request, the user request screen control section 9 sends to the user request search section 7 the receipt of a further request for acquiring only those image objects for which the [image creating user] is “XXX Taro” (Flow 2-8). Then, the user request search section 7 issues to the context metadata extraction section 5, as a further search condition, a search formula to inquire about the identifiers of image objects for which the [image creating user] is “XXX Taro” (Flow 2-9).

If there exists any corresponding image object as a result of an assessment of this search formula with respect to a table of FIG. 8 (Flow 2-10), the user request search section 7 acquires from the document image management section 2 image data of target image objects by making inquiries to the table of FIG. 6 based on the identifier of the corresponding image object (Flow 2-11).

In addition, the search result screen forming section 8 achieves a filtering function (listing a plurality of document images and image objects in an appropriately changed manner by further forming, with respect to the list on the screen formed in Flow 2-6, a screen to present a list of only image data information of the acquired image objects (a screen control step (a user request screen control step): Flow 2-12).

### Embodiment 3

In a third embodiment of the present invention, provision is further made for a user situation determination search section 10 and a user situation determination screen control section 11 in addition to the configuration of the second embodiment.

An example of processing performed by these sections will be described below.

When a user operates a screen displayed on a screen display device 102, the user situation determination search section 10 can recognize that an image reader 101 to which the screen display device 102 is directly connected is “FP_{—}01”. Accordingly, the user situation determination search section 10 can select, from among already a registered documents images, only those documents for which the [image creating device] is “MFP_{—}01”, with respect to the user request search section 7.

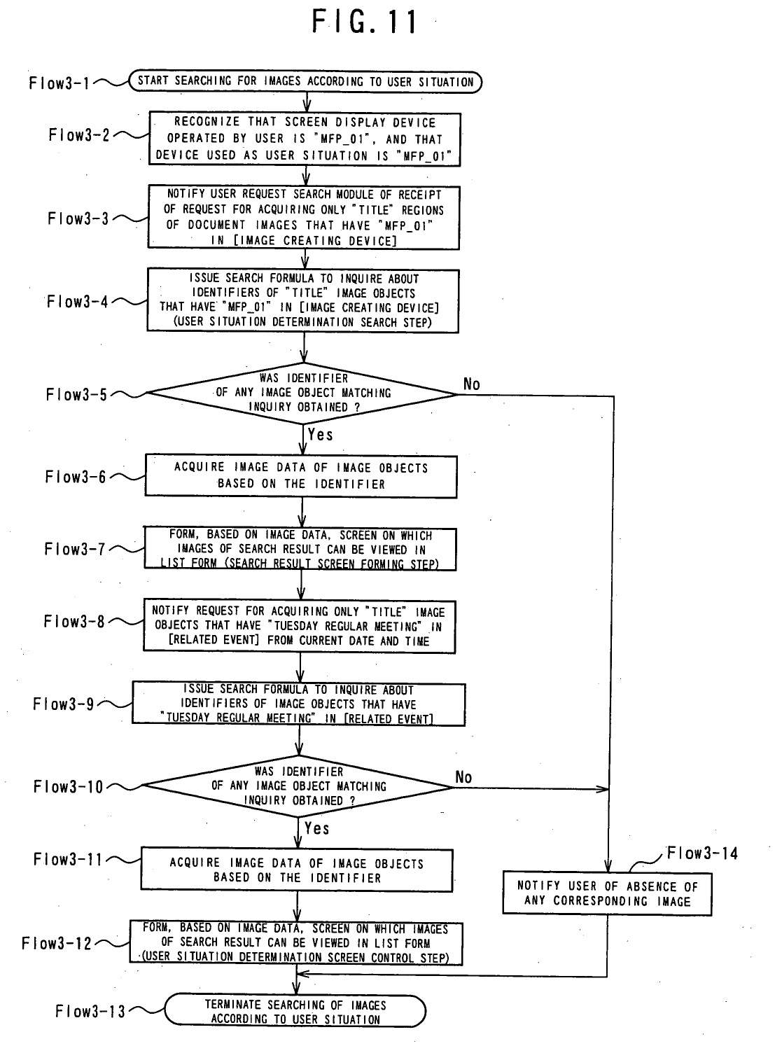

In addition, from the date and time at which the user operated a screen, the dates and times at which operations of a similar tendency were carried out in the past are estimated as regular events so that the screen is controlled to filter only those documents which are related to the events. Hereinbelow, reference will be made to the operation of the third embodiment of the present invention while using a flow chart shown in FIG. 11. First of all, from the screen display device 102 operated by the user being MFP_{—}01, the user situation determination search section 10 recognizes, with respect to the situation where the user is located, i.e., in what place the user is at present, that the user is in the place where “MFP_{—}01” is installed or arranged (Flow 3-2). Thus, the user situation determination search section 10 sends to the user request search section 7 a request that the user wants to view a list of image objects recognized as titles for already registered document images which were created by the “MFP_{—}01” Flow 3-3′).

The user request search section 7 issues to the context metadata management section 6 and the content metadata management section 4 a search formula to inquire about the identifier(s) (one or more) of the image objects which have “MFP_{—}01” in the value of the “image creating device” and “title” in the value of the [semantic area of each image] (a user request search step (a user situation determination search step): Flow 3-4). If there exists any image object inquired about as a result of an assessment of this search formula with respect to the tables of FIG. 7 and FIG. 8 (Flow 3-5), the user request search section 7 acquires image data of target image objects from the document image management section 2 by making inquiries to the table of FIG. 6 based on the identifier of the image object (Flow 3-6).

Next, the search result screen forming section 8 forms a screen to present a list of image objects based on the image data thus acquired (a search result screen forming step: Flow 3-7). As shown in FIG. 10, this screen is such that only image objects for the “title” are arranged so as to be easily identified. The screen thus formed is presented to the user by being displayed on the screen display device 102. The user can easily find out a desired image by freely scrolling the screen arranged in this manner. In addition, when a desired document can be found based on the image object of its “title”, by forming, through designation of the image of the document by clicking for example, such a screen as to display an entire original document image or all the pages thereof if a plurality of pages exist, it is possible to ascertain the content thereof.

If there exists no corresponding image object in Flow 3-5 the search result screen forming section 8 notifies the user of the absence of any corresponding image (Flow 3-14). This can be notified to the user by a screen describing to that effect being formed by the search result screen forming section 8 and being displayed on the screen display device 102.

Although the user tries to search for a desired document from the list of image objects of the “title” with the [image creating device] being “MFP_{—}01”, it is difficult for the user to find the desired document from there if there are a lot of image objects in this list. In such a case, the user situation determination screen control section 11 automatically determines the situation of the user, and provides it as a filter condition so that only those which are in much with the condition can be listed, thereby making it easy to find the document. Reference will be made, as such an example, to the case where from the date and time at which the user did an operation, a corresponding event in the real world is estimated. Here, as stated above, it is assumed that event information is managed by a mailer or a schedule management system, and when a work or operation is performed by a certain device at a certain date and time, a corresponding event can be estimated from that information and acquired as data.

The user situation determination screen control section 11 determines, from the present date and time at which an operation is being carried out and a screen display device 102 which is being operated, that the user performs a certain operation about a “Tuesday regular meeting” as a related event.

For instance, in case where the date and time of the holding of the “Tuesday regular meeting” is from 13:00 to 15:00 every Tuesday and the place of holding is a meeting room A, it is determined, from the date of an operation being 12:50 on Tuesday and the device operated being a one “MFP_{—}01” installed in the meeting room A, that the operation is the one that is related to the “Tuesday regular meeting”. Thus, the user situation determination screen control section 11 sends to the user request search section 7 an already registered document image as a request that the user wants to view a list of image objects which have a “Tuesday regular meeting” as an event related to the image and which were recognized as titles for the image (Flow 3-8).

The user situation determination search section 10 issues to the context metadata management section 6 and the content metadata management section 4 a search formula to inquire about the identifier(s) (one or more) of the image objects which have a “Tuesday regular meeting” in the value of the [related event] and a “title” in the value of the [semantic area of each image] Flow 3-9).

If there exists any image object inquired about as a result of an assessment of this search formula with respect to the tables of FIG. 8 and FIG. 7 (Flow 3-10), the user situation determination search section 10 acquires image data of target image objects from the document image management section 2 by making inquiries of to the table of FIG. 6 based on the identifier of the image object (Flow 3-11).

In addition, the search result screen forming section 8 achieves a filtering function by further forming, with respect to the list on the screen formed in Flow 3-7, a screen to present a list of only image data information of the acquired image objects a screen control step (a user situation determination screen control step): Flow 3-12).

### Embodiment 4

In a fourth embodiment of the present invention, provision is further made for a managed document metadata extraction section 12 in addition to the configuration of the third embodiment.

In this example, reference will be made to the case where an already registered document image is printed by means of a printing device 103.

When a document image is printed by a printing device 103, the document image as a result of the printing is newly produced as a document in the media of paper. The managed document metadata extraction section 12 extracts semantic attribute information of a situation such as a work or operation, a peripheral environment. etc., as in the case of the context metadata extraction section 5. Although this extraction step constitutes a managed document metadata extraction step of the present invention, a detailed operation thereof is similar to those shown in FIG. 4, FIG. 9 and FIG. 11, and hence an explanation thereof is omitted here.

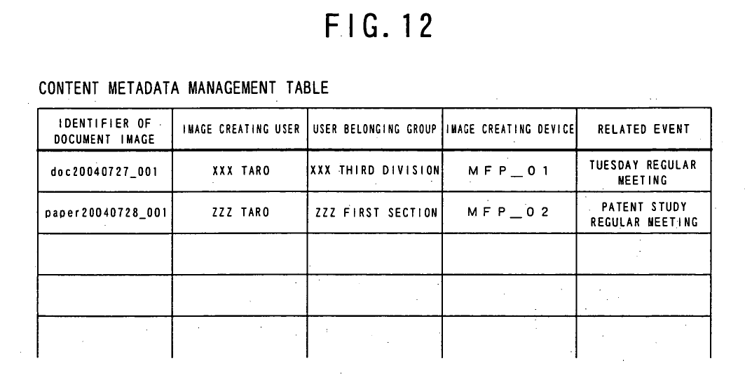

FIG. 12 illustrates context metadata related to documents, which are managed in a table of the context metadata management section 6. When each document is printed on paper for example, an identifier assigned here is printed in the form of an electronic watermark, a bar code, etc., and attached to a paper media in such a state that it can be read again by scanning. The context metadata managed in this manner can be made a search object, similar to other metadata, in searches as described in the second and third embodiments.

The document image information management apparatus in the above-mentioned embodiments can manage a variety of kinds of metadata in an integrated manner, and also can perform management with the metadata and documents being associated with one another. In addition, in this case, the documents are managed by units of objects in individual regions in their images. According to this apparatus, it is possible to search for and operate the documents by making use of the metadata thus managed, and at the same time it is also possible to acquire and view documents needed by the user in units of objects in regions thereof. Further, there is achieved an advantageous effect that information on the managed documents can be continuously collected and integrally managed.

Although in the embodiments of the present invention, there has been described the case where functions (programs) to achieve the invention are prerecorded in the interior of the apparatus, the present invention is not limited to this but similar functions can be downloaded into the apparatus via a network. Alternatively, a recording medium storing therein similar functions can be installed into the apparatus. Such a recording medium can be of any form such as a CD-ROM, which is able to store programs and which is able to be read out by the apparatus. In addition, the functions to be obtained by such preinstallation or downloading can be achieved through cooperation with an OS (operating system) or the like in the interior of the apparatus.

What is claimed is:

1. A document image information management apparatus for managing metadata of contents and contexts related to document images, said apparatus comprising:
an image analyzing section that analyzes prescribed image regions as image objects based on image contents of said document images; a content metadata extraction section that extracts attribute information based on contents of said image objects analyzed by said image analyzing section;
a content metadata management section that manages metadata of said contents extracted by said content metadata extraction section in association with said document images and said image objects;
a context metadata extraction section that extracts attribute information based on a situation of documents of said document images; and
a context metadata management section that manages the metadata of said contexts extracted by said context metadata extraction section in association with said document images and said image objects.

2. The document image information management apparatus according to claim 1, further comprising:
a search section that issues a search key for said content metadata managed by said content metadata management section and said context metadata managed by said context metadata management section, and searches for said document images and said image objects based on said search key.

3. The document image information management apparatus according to claim 2, wherein
said search section comprises a user request search section that issues a search key based on a user request.

4. The document image information management apparatus according to claim 2, wherein
said search section comprises a user situation determination search section that determines a user situation and issues a search key.

5. The document image information management apparatus according to claim 2, further comprising:
a search result screen forming section that forms a screen to display said document images and said image objects searched by said search section.

6. The document image information management apparatus according to claim 5, wherein
when a plurality of document images and image objects are searched by said search section, said search result screen forming section displays a list of said plurality of document images and image objects while changing said searched document images and image objects by using other prescribed metadata different from said search key.

7. The document image information management apparatus according to claim 5, further comprising:
a user request screen control section that performs display control on the screen formed by said search result screen forming section based on a user request.

8. The document image information management apparatus according to claim 5, further comprising:
a user situation determination screen control section that determines a user situation with respect to the screen formed by said search result screen forming section, and performs display control in accordance with the user situation thus determined.

9. The document image information management apparatus according to claim 1, further comprising:
a managed document metadata extraction section that extracts metadata of contexts for a work performed to said document images and image objects managed in said content metadata management section or said context metadata management section.

10. A document image information management program for making a computer perform management of metadata of contents and contexts related to document images, said program adapted to make said computer execute:
an image analyzing step of analyzing prescribed image regions as image objects based on image contents of said document images;
a content metadata extraction step of extracting attribute information based on contents of said image objects analyzed in said image analyzing step;
a content metadata management step of managing metadata of said contents extracted in said content metadata extraction step in association with said document images and said image objects;
a context metadata extraction step of extracting attribute information based on a situation of documents of said document images; and
a context metadata management step of managing the metadata of said contexts extracted in said context metadata extraction step in association with said document images and said image objects.

11. The document image information management program according to claim 10, said program adapted to make said computer execute:
a search step of issuing a search key for said content metadata managed in said content metadata management step and said context metadata managed in said context metadata management step, and searching for said document images and said image objects based on said search key.

12. The document image information management program according to claim 11, wherein
said search step makes said computer execute a user request search step of issuing a search key based on a user request to perform a search.

13. The document image information management program according to claim 11, wherein
said search step makes said computer execute a user situation determination search step of determining a user situation and issuing a search key to perform a search.

14. The document image information management program according to claim 11, said the program adapted to make said computer execute:
a search result screen forming step of forming a screen to display said document images and said image objects searched in said search step.

15. The document image information management program according to claim 14, wherein
said search result screen forming step makes said computer execute a screen control step of displaying, upon a plurality of document images and image objects being searched in said search step, a list of said plurality of document images and image objects while changing said searched document images and image objects by using other prescribed metadata different from said search key.

16. The document image information management program according to claim 14, said the program adapted to make said computer execute:
a user request screen control step of performing display control on the screen formed in said search result screen forming step based on a user request.

17. The document image information management program according to claim 14, said program adapted to make said computer execute:
a user situation determination screen control step of determining a user situation with respect to the screen formed in said search result screen forming step, and performing display control in accordance with the user situation thus determined.

18. The document image information management program according to claim 10, said program adapted to make said computer execute:
a managed document metadata extraction step of extracting metadata of contexts for a work performed to said document images and image objects managed in said content metadata management step or said context metadata management step.
